(19) United States
(12) Patent Application Publication
(10) Pub. No.: US 2024/0423198 A1
(43) Pub. Date: Dec. 26, 2024

(54) SUSPENSION CONCENTRATE DISPERSANTS

(71) Applicant: Croda International PIc, Goole, East Yorkshire (GB)

(72) Inventors: Kathryn Knight, Goole, East Yorkshire (GB); James Flavell, Goole, East Yorkshire (GB)

(73) Assignee: Croda International PIc, Goole, East Yorkshire (GB)

(21) Appl. No.: 18/708,232

(22) PCT Filed: Nov. 8, 2022
(86) PCT No.: PCT/EP2022/081103

§ 371 Date: May 8, 2024

(30) Foreign Application Priority Data
Nov. 9, 2021 (GB) 2116069.2

(51) Int. Cl. A01N 25/04; A01N 25/10; A01N 43/653; A01N 43/82

(52) U.S. Cl. CPC A01N 25/04; A01N 25/10; A01N 43/653; A01N 43/82

(57) ABSTRACT

Suspension concentrate dispersants A novel suspension type water medium agrochemical formulation comprising adjuvants selected from a copolymer dispersant comprising a copolymer of acrylic 5 acid, hydrophobic monomer, alkylacrylate of a monoalkyl polyethylene glycol, C10 to C30 alkoxylated mono- and/or di-ester phosphate, and optionally strong acid derivatives of (meth)acrylic acid; non-ionic graft copolymer of acrylic ester and oxyalkylene; and having hydrophobic solid agrochemical active dispersed in aid water medium. A concentrate is also provided suitable for forming the formulation. The 10 combination of copolymers provide dispersancy for the hydrophobic solid agrochemical active in the water medium of the suspension concentrate withsignificantly reduced crystal growth. There is also provided the use of said copolymers as dispersants for hydrophobic solid agrochemical active in agrochemical formulations. and a method of treating vegetation to control pests by applying the 15formulation or diluted concentrate form of the formulation to vegetation or the immediate environment. 20

The present invention relates to polymer dispersants for suspension-type agrochemical formulations with hydrophobic solid agrochemical actives, and a method of providing dispersancy including crystal growth inhibition in said agrochemical formulations. The present invention also includes methods of treating crops with such formulations.

Agrochemical formulations typically include dissolved or dispersed components such as actives and additives or dispersants are often added to formulations to help disperse these components.

Regulations are driving a trend to more water based systems which causes problems for actives that are not very water soluble (hydrophobic sparingly soluble). Additionally, often when more active is included in a formulation this can lead to unfavourable crystal growth.

Water-based agrochemical formulations and/or dilutions have deficiencies in certain circumstances, and in many cases can often be improved upon. It is also known that when a hydrophobic solid is dispersed, to some extent the physical act of dispersion breaks apart the particulate crystals or particle aggregations (hereinafter referred to simply as ‘crystals’) that are subsequently stabilised by dispersing aids and/or additional surfactants. However, upon storage or standing, the particles can recrystallise into large, aggregate particles. It is believed that crystal growth or aggregation is caused by continual reciprocal collision of the fine particles due to Van der Waal's forces. The fine particles may become aggregated and as a result they sediment like clay. At that stage it becomes difficult to disperse the aggregates. Smaller crystals/particulates are desired to impart better application and efficacy.

A particular problem with agrochemical formulations is there is an increasing difficulty in dispersing actives, and this is especially an issue due to the trend for using less or sparingly soluble actives. These actives can increase the possibility of Ostwald ripening ripening and/or crystal growth.

Owing to known physical laws, the small crystal particles having a high surface energy are dissolved, whereas the larger particles already present continue to grow, their ultimate size depending upon the solubility conditions

Use of some solvents as stabilisers in preparing suspension-type agrochemical formulations in which the agrochemical is soluble may not provide an effective formulation. These types of solvents can also lead to accelerated crystal growth of the agrochemical active.

Therefore, there is a need to find dispersants which allow for formation of suspension type with hydrophobic sparingly soluble actives, and which wholly or substantially reduce crystal growth and the instability of the formulation.

The present invention seeks to provide compounds suitable for use as dispersants in agrochemical formulations, where said dispersants are able to overcome the above described problems. Additionally, the present invention seeks to provide dispersants which have desired properties such as dispersancy of hydrophobic solid actives in suspension type formulations. The present invention also seeks to provide the use of agrochemical concentrates and dilute formulations comprising said dispersants. The present invention also seeks to provide effective steric and electrostatic stability to a formulation.

The present invention provides suspension-type agrochemical formulations prepared by dispersing fine particles of a hydrophobic solid agrochemical in an aqueous medium and helps reduce and/or prevent flocculation and agglomeration.

According to a first aspect of the present invention there is provided a suspension type water medium agrochemical formulation comprising;
i) copolymer dispersant comprising a copolymer of acrylic acid, hydrophobic monomer, alkylacrylate of a monoalkyl polyethylene glycol, and optionally strong acid derivatives of (meth)acrylic acid;
ii) C10 to C30 alkoxylated mono- and/or di-ester phosphate;
iii) optionally non-ionic graft copolymer of acrylic ester and oxyalkylene; and
iv) at least one hydrophobic solid agrochemical active dispersed in said water medium.

According to a second aspect of the present invention there is provided a concentrate formulation suitable for making an agrochemical formulation of the first aspect, said concentrate comprising;
i) copolymer dispersant comprising a copolymer of acrylic acid, hydrophobic monomer, alkylacrylate of a monoalkyl polyethylene glycol, and optionally strong acid derivatives of (meth)acrylic acid;
ii) C10 to C30 alkoxylated mono- and/or di-ester phosphate;
iii) optionally non-ionic graft copolymer of acrylic ester and oxyalkylene; and
iv) at least one hydrophobic solid agrochemical active dispersed in said water medium.

According to a third aspect of the present invention there is provided the use of a combination of:
copolymer of acrylic acid, hydrophobic monomer, alkylacrylate of a monoalkyl polyethylene glycol, and optionally strong acid derivatives of (meth)acrylic acid;
C10 to C30 alkoxylated mono- and/or di-ester phosphate; and
optionally non-ionic graft copolymer of acrylic esters and oxyalkylene;
   as a dispersant in an agrochemical formulation comprising hydrophobic solid agrochemical active.

According to a fourth aspect of the present invention there is provided a method of treating vegetation to control pests, the method comprising applying a formulation of the first aspect, and/or a diluted concentrate formulation of the second aspect, either to said vegetation or to the immediate environment of said vegetation.

It has been found that a combination of polymers formed from acrylic acid, hydrophobic monomer, alkylacrylate of a monoalkyl polyethylene glycol, optionally strong acid derivatives of (meth)acrylic acid, with a C10 to C30 alkoxylated mono- and/or di-ester phosphate, and optionally a non-ionic graft copolymer of acrylic ester and oxyalkylene, provide for desired dispersancy properties when used in a suspension type agrochemical formulation having at hydrophobic solid agrochemical active, with significantly reduced crystal growth.

As used herein, the terms ‘for example,’ ‘for instance,’ ‘such as,’ or ‘including’ are meant to introduce examples that further clarify more general subject matter. Unless otherwise specified, these examples are provided only as an aid for understanding the applications illustrated in the present disclosure, and are not meant to be limiting in any fashion.

It will be understood that, when describing the number of carbon atoms in a substituent group (e.g. ‘C1 to C6 alkyl’), the number refers to the total number of carbon atoms present in the substituent group, including any present in any branched groups. Additionally, when describing the number of carbon atoms in, for example fatty acids, this refers to the total number of carbon atoms including the one at the carboxylic acid, and any present in any branch groups.

The copolymer dispersant comprises a copolymer of acrylic acid, hydrophobic monomer, alkylacrylate of a monoalkyl polyethylene glycol, and optionally strong acid derivatives of (meth)acrylic acid.

The acrylic acid monomer used to form the copolymer may be selected from (meth)acrylic acid or salts thereof, (meth)acrylamide, (meth)acrylonitrile, C1-6-alkyl (meth)acrylates such as ethyl (meth)acrylate, butyl (meth)acrylate or hexyl (meth)acrylate, 2-ethylhexyl (meth)acrylate, substituted C1-6-alkyl (meth)acrylates such as glycidyl methacrylate and acetoacetoxyethyl methacrylate, di(C1-4-alkylamino)C1-6-alkyl (meth)acrylates such as dimethylaminoethyl acrylate or diethylaminoethyl acrylate, amides formed from C1-6-alkylamines, substituted C1-6-alkyl-amines such as 2-amino-2-methyl-1-propane sulphonic acid, ammonium salt, or di(C1-4-alkyl-amino)C1-6-alkylamines and (meth)acrylic acid and C1-4-alkyl halide adducts thereof.

Preferably the acrylic acid monomer may be acrylic acid, methacrylic acid, crotonic acid, or a mixture thereof. More preferably, the monomer is acrylic acid.

The hydrophobic monomer may be selected from any monomer which is water insoluble. In particular, the hydrophobic monomer may be selected from hydrophobic alkyl (meth)acrylates, styrenes, and vinyl compounds, and vinyl aromatic monomers.

In particular vinyl aromatic monomers may be preferred.

The vinyl aromatic monomer(s) can be, and desirably is, styrene as such or a substituted styrene particularly a hydrocarbyl, desirably alkyl, substituted styrene, in which the substituent(s) are on the vinyl group or on the aromatic ring of the styrene e.g. α-methyl styrene and vinyl toluene.

Suitable vinyl aromatic monomers may preferably comprise from 8 to 20 carbon atoms, most preferably from 8 to 14 carbon atoms. Styrenes and substituted styrenes are preferred where the substituent group, if present, are C1-C6 alkyl groups.

Examples of vinyl aromatic monomers are styrene including substituted styrene, 1-vinyl naphthalene, 2-vinyl naphthalene, 3-methyl styrene, 4-propyl styrene, t-butyl styrene, 4-cyclohexyl styrene, 4-dodecyl styrene, 2-ethyl-4-benzyl styrene, 4-(phenylbutyl) styrene, alpha-methylstyrene, and halogenated styrenes.

The styrene monomer can be or may also comprise styrene monomers including strongly acidic, particularly sulphonic acid, substituents. When present such strong acid modified monomers usually form from 1 to 30 mol. %, more usually 2 to 20 mol. %, and desirably from 5 to 15 mol. %, of the styrene monomers in the copolymer.

Preferably the hydrophobic monomer may be styrene, a-methyl styrene, p-methyl styrene, t-butyl styrene, or a combination thereof. More preferably, the hydrophobic monomer may be styrene.

The alkylacrylate of a monoalkyl polyethylene glycol may preferably be a non-ionic hydrophilic monomer.

The alkyl group either as part of the alkylacrylate or monoalkyl groups, may independently be selected from a C1-C6 alkyl, and in particular a C1-C3 alkyl. The alkyl group may preferably be selected from methyl, ethyl, n-butyl, or t-butyl. Preferably the alkyl group is methyl.

The number-average molecular mass of the monoalkyl polyethylene glycol (i.e. the PEG chain only and not the whole alkylacrylate of a monoalkyl polyethylene glycol) may be at least 300 daltons, preferably ranging from 350 to 900 daltons, more preferably in the range from 400 to 600 daltons.

Some of the monoalkyl polyethylene glycols employed as initial materials in this invention occur in commerce. Thus methyl ethers of total molecular weights of 500 and 550, and designated, respectively, in commerce as methoxy polyethylene glycol 550 and methoxy polyethylene glycol 750, are available on the market.

Preferably, the alkylacrylate of a monoalkyl polyethylene glycol is a methoxy polyethylene glycol methacrylate (MPEGMA), and more particularly a methoxy polyethylene glycol 500 methacrylate.

Strong acid derivatives of (meth)acrylic acid, may include strong acids comprising sulphate acid or sulphonic acid groups (or their salts). Examples of such monomers include acrylamido methyl propyl sulphonate (AMPS) and (meth)acrylic acid isethionate.

When present such strong acid modified monomers usually form from 1 to 30 mol. %, more usually 2 to 20 mol. %, and desirably from 5 to 15 mol. %, of the acrylic acid monomers in the copolymer.

The polymer may be formed from hydrophobic monomers and may be a water soluble polymer, said solubility arising as a result of neutralisation of the polymer.

It will be understood that the terms “copolymer” as used herein includes polymers with two components as well as ter-polymers and terta polymers, and generally any polymer with two or more components. The copolymer may preferably be a random ter-polymer or tetra polymer, optionally with a strong acid derivatives of (meth)acrylic acid monomer.

The copolymer may be formed by any suitable method, and this may include free radical solution polymerisation or controlled living polymerisation. The monomers may be added concurrently in a controlled manor over a period of time with suitable initiator.

The amount of acrylic acid monomer present in the polymer may be in the range from 10 wt. % to 90 wt. %. Preferably, 15 wt. % to 60 wt. %. More preferably from, 20 wt. % to 50 wt. %. Most preferably, from 30 wt. % to 40wt. %.

The amount of vinyl aromatic monomer present in the polymer may be in the range from 10 wt. % to 90 wt. %. Preferably, 15 wt. % to 60 wt. %. More preferably from, 15 wt. % to 40 wt. %. Most preferably, from 20 wt. % to 30 wt. %.

The amount of alkylacrylate of a polyethylene glycol monomer present in the polymer may be in the range from 10 wt. % to 90 wt. %. Preferably, 15 wt. % to 60 wt. %. More preferably from, 20 wt. % to 50 wt. %. Most preferably, from 30 wt. % to 40 wt. %.

When present such strong acid modified monomers usually form from 1 to 30 mol. %, more usually 2 to 20 mol. %, and desirably from 5 to 15 mol. %, of the acrylic acid monomers in the copolymer.

Other monomers, such as acidic monomers e.g. itaconic acid or maleic acid or anhydride; strongly acidic monomers such as methallyl sulphonic acid (or a salt); or non-acidic acrylic monomers e.g. acrylic esters which may be alkyl esters particularly C1 to C6 alkyl esters such as methyl methacrylate, butyl methacrylate or butyl acrylate or hydroxy alkyl esters particularly C1 to C6 hydroxyalkyl esters such as hydroxy ethyl methacrylate, or hydroxy propyl methacrylate; or vinyl monomers such as vinyl acetate, can be included. Typically, the proportion of such other monomer(s) will be not more than about 10 mol. %, usually not more than about 7 mol. %, more usually not more than about 5 mol. %, of the total monomers used.

The inclusion of monomers having strongly acidic substituent groups in the polymeric dispersant can provide improved dispersion of the solid granular form of the agrochemical formulations when dispersed in hard water, particularly water having a hardness above 500 ppm e.g. up to 1,000 ppm, up to 2,000 ppm or even up to 5,000 ppm.

The polymer may have a molecular weight less than 500,000 Daltons. Preferably, less than 100,000 Daltons. More preferably, less than 75,000 Daltons. The molecular weight may be in the range from 5,000 to 75,000 Daltons. More preferably, in the range from 10,000 to 60,000 Daltons. Further preferably, in the range from 15,000 to 50,000 Daltons. Most preferably, in the range from 20,000 to 40,000 Daltons.

The polymer can be used as the free acid or as a salt. In practice, the form present in a formulation will be determined by the acidity of the formulation. Desirably, the formulation will be near neutral and so most of the acid groups will be present as salts. The cations in any such salt can be alkali metal, particularly sodium and/or potassium, ammonium, or amine, including alkanolamine such as ethanolamine, particularly tri-ethanolamine. In particular, sodium or potassium salts forms of the stabilising polymer are preferred.

The neutralisation with at least 70%, and preferably 75%- 85%. Neutralisation with sodium is preferred.

The pH of the polymer may be in the range from 4.0 to 11.0. More preferably, in the range from 5.0 to 10.0. Further preferably, in the range from 5.5 to 9.0. Most preferably, in the range from 6.0 to 8.0.

The suspension type water medium agrochemical formulation also comprises a C10 to C30 alkoxylated mono- and/or di-ester phosphate.

The monoester phosphate suitably comprises, consists essentially of, or consists of compounds of formula R¹-(AO)ₙ—O—P(═O)(OH)₂.

The diester phosphate suitably comprises, consists essentially of, or consists of compounds of formula R²-(AO)ₙ—O—P(═O)—O-(AO)ₙ—R³)(OH).

R¹, R², and R³ are independently suitably a C10 to C30 hydrocarbyl group, preferably an alkyl group. R¹, R², and R³ are independently preferably a C12 to C24, more preferably C14 to C20, particularly C16 to C18, and especially C16 hydrocarbyl group, particularly alkyl group.

R¹, R², and R³ independently may be saturated or unsaturated, linear or branched, but are preferably saturated. The hydrocarbyl group may be linear or branched, but is preferably linear. Most preferably, the hydrocarbyl group is saturated and linear.

Where the phosphate ester is a diester, the R² and R³ groups may be the same or different, and therefore the diester phosphate may be symmetrically or asymmetrically substituted.

The oxyalkylene groups (AO) may be selected from groups of the formula —(C_{y}H_{2y}O)— where y is an integer selected from 2, 3, or 4. Preferably, y is 2 or 3. The oxyalkylene group AO may be selected from oxyethylene, oxypropylene, or oxybutylene. Preferably, the oxyalkylene group is selected from oxyethylene (EO) or oxypropylene (PO).

Where the oxyalkylene chain is homopolymeric, homopolymers of oxyethylene or oxypropylene are preferred.

Where there is more than one oxyalkylene group present (i.e. where n is 2 or more) and at least two are part of the same oxyalkylene chain, the oxyalkylene groups may be different along said oxyalkylene chain. In this embodiment, the oxyalkylene chain may be a block or random copolymer of differing oxyalkylene groups.

Preferably the oxyalkylene chain comprises two different oxyalklene groups, preferably a mixture of oxyethylene and oxypropylene. More preferably, the oxyalkylene chain in this embodiment is a block copolymer of the two different oxyalklene groups.

Usually, where co-polymeric chains of ethylene and propylene oxide units are used the molar proportion of ethylene oxide units used will be at least 50%, preferably at least 60%, and more preferably at least 70%.

The number of alkylene oxide residues in the (poly)alkylene oxide chains, i.e. the value of the each parameter n, will preferably be in the range from 2 to 30, more preferably 5 to 22, particularly 7 to 18, and most preferably 10 to 15.

Where the phosphate ester is a diester, the oxyalkylene chain on each of the ester substituted chains is independently selected for oxyalklene groups and values of n. For a diester, thus each of the oxyalkylene chains may be identical or may be different.

The C10 to C30 mono- and/or di-ester phosphate used in the present invention may be homogeneous, or may comprise a mixture of mono and di-ester phosphate. Mixtures of mono and di-ester phosphate may be preferred.

The molar ratio of monoester phosphate to diester phosphate present in a composition according to the present invention may be in the range from 0 to 100%: 0 to 100%, but is preferably 40 to 95%: 5 to 60%, more preferably 50 to 85%: 15 to 50%, especially 60 to 75%: 25 to 40%, and especially 65 to 70%: 30 to 35%.

The phosphate esters used in the present invention may be suitably formed, as is known in the art, by reacting a fatty alcohol, e.g. of formula R¹/R²/R³—OH, wherein R¹/R²/R³ are as defined above, with a phosphorylating agent such polyphosphoric acid, phosphorus pentoxide, oxychloride or trichloride. In one embodiment, phosphorus pentoxide is preferred. The reaction can produce a statistical mixture of mono-, and di-ester products and the proportions can be controlled to produce the desired ratio of esters, e.g. monoester: diester ratio, for example by varying the proportions of the starting materials.

Suitable linear fatty alcohols include cetyl alcohol, stearyl alcohol, oleyl alcohol, lauryl alcohol, cocoyl alcohol, tetradecanol, arachidyl alcohol, behenyl alcohol and lignoceryl alcohol. Suitable branched fatty alcohols include isostearyl alcohol, isotetradecanol, isocetyl alcohol, isoarachidyl alcohol, isobehenyl alcohol and isolignoceryl alcohol; neo-alcohols such as neocapric alcohol; and/or anti-iso alcohols. Linear fatty alcohols are preferred, particularly cetyl alcohol and/or stearyl alcohol, and especially cetyl alcohol.

In one preferred embodiment, R¹, R², and R³ are each independently a mixture of linear C16 and C18 alkyl groups, i.e. the fatty alcohol is cetyl alcohol and stearyl alcohol (cetostearyl alcohol), preferably present at a weight ratio of stearyl alcohol:cetyl alcohol in the range from 0.3 to 10:1, more preferably 1 to 5:1, particularly 1.5 to 3.5:1, and especially 2 to 2.8:1.

In one embodiment, the phosphate ester and fatty alcohol components are pre-mixed prior to combining with the organic medium to form the composition according to the present invention.

Particularly preferred phosphate esters may be selected from cetyl (10 EO, 5 PO) mono ester phosphate, cetyl (10 EO, 5 PO) di ester phosphate, stearyl (10 EO, 5 PO) mono ester phosphate, stearyl (10 EO, 5 PO) di ester phosphate, tridecyl (6 EO) mono ester phosphate, tridecyl (6 EO) di ester phosphate, castor oil (12 EO) mono phosphate, and castor oil (12 EO) di phosphate.

The formulation may optionally comprise a non-ionic graft copolymer of acrylic ester and oxyalkylene.

The acrylic ester may be a non-acidic acrylic monomers, for example acrylic esters which may be selected from alkyl esters, particularly C1 to C6 alkyl esters. Preferably, said alkyl esters may be selected from methyl methacrylate, butyl methacrylate or butyl acrylate. Most preferably, methyl methacrylate.

The number of acrylic ester monomer residues in the (poly) acrylic ester chains, will preferably be in the range from 2 to 50, more preferably 5 to 40, and particularly 10 to 30.

The oxyalkylene groups may be selected from groups of the formula —(C_{y}H_{2y}O)— where y is an integer selected from 2, 3, or 4. Preferably, y is 2 or 3.

The oxyalkylene group may be selected from oxyethylene, oxypropylene, oxybutylene, or oxytetramethylene. Preferably, the oxyalkylene group is selected from oxyethylene (EO) and/or oxypropylene (PO).

Where the oxyalkylene chain is homopolymeric, homopolymers of ethylene oxide or propylene oxide are preferred. More preferably, homopolymers of ethylene oxide are particularly preferred.

Where there is more than one oxyalkylene group present (i.e. where n is 2 or more) and at least two are part of the same oxyalkylene chain, the oxyalkylene groups may be the same or may be different along said oxyalkylene chain. In this embodiment, the oxyalkylene chain may be a block or random copolymer of differing oxyalkylene groups.

Usually, where co-polymeric chains of oxyethylene and oxypropylene units are used the molar proportion of oxyethylene units used will be at least 50% and more usually at least 70%.

The total number of alkylene oxide residues in the (poly) alkylene oxide chains, will preferably be in the range from 2 to 50, more preferably 5 to 40, and particularly 10 to 25.

The molecular weight of the non-ionic graft copolymer of acrylic ester and oxyalkylene is typically from 5,000 to 40,000, particularly from 7,000 to 30,000, more particularly from 8,000 to 25,000 and especially about 9,000 to 18,000.

Any non-ionic graft copolymer of acrylic ester and oxyalkylene may be used. Preferably, the copolymer may be non-ionic polymethyl methacrylate-polyethylene oxide graft copolymer.

Agrochemical actives for use in the formulations according to the invention are hydrophobic solid agrochemical active. These are agrochemically active compounds that are solid at room temperature.

In agrochemistry, the logarithm of the ratio of the concentrations of the unionised solute in two solvents, respectively octanol and water, is used as an index of the pesticide lipophilicity, and is known as the octanol/water coefficient, logP. The agrochemically active may have a logP value of over 2.5. More preferably, in the range from 2.5 to 4.5.

Agrochemical actives refer to biocides which, in the context of the present invention, are plant protection agents, more particular chemical substances capable of killing different forms of living organisms used in fields such as medicine, agriculture, forestry, and mosquito control. Also counted under the group of biocides are so- called plant growth regulators.

Biocides for use in agrochemical formulations of the present invention are typically divided into two sub-groups:
pesticides, including fungicides, herbicides, insecticides, algicides, moluscicides, miticides and rodenticides, and
antimicrobials, including germicides, antibiotics, antibacterials, antivirals, antifungals, antiprotozoals and antiparasites.

In particular, biocides selected from insecticides, fungicides, or herbicides may be particularly preferred.

In the present invention, hydrophobic solid agrochemicals means those which are very slightly soluble or practically insoluble in water.

Typical agrochemicals for use in in the present invention may include:
herbicides such as, for example, flufenacet, bromoxynil octanoate, trifluralin, benfluralin, isouron, metribuzin, daimuron, ametryn, dichlobanil, alachlor, linuron, diuron;
fungicides such as, for example, isoprothiolane, chlorothalonil; azole fungicides selected from difenoconazole, cyproconazole, prothioconazole, epoxiconazole, tebuconazole, prochloraz, penconazole, flusilazole, metconazole, triadimenol, hexaconazole, flutriazole, triflumizole; fenbuconazole, bromconazole, fluquinconazole, azaconazole, triticonazole, triazimephone, and imibenconazole; strobilurin analogues such as kresoxim-methyl and pyraclostorubin; maneb, mancozeb, ziram, thiram;
insecticides such as, for example, dimethylethylsulfinyl isopropylthiophosphate, metolcarb, phosalone, buprofezin, azoxystrobin, methyl isothiocyanate;
and mixtures thereof.

Most preferably, the active present in the agrochemical formulation of the present invention is selected from herbicides such as flufenacet, or metribuzin; azoles fungicides such as difenoconazole, cyproconazole, prothioconazole, azoxystrobin; or insecticides such as buprofezin or azoxystrobin.

In particular, combinations of actives such as azoxystrobin with cyproconazole and/or difenoconazole may be preferred.

Agrochemically active compounds, including insecticides and fungicides, require a formulation which allows the active compounds to be taken up by the plant/the target organisms.

The term ‘agrochemical formulation’ as used herein refers to compositions including an active agrochemical, and is intended to include all forms of compositions, including concentrates and spray formulations. If not specifically stated, the agrochemical formulation of the present invention may be in the form of a concentrate, a diluted concentrate, or a sprayable formulation.

The dispersant of the present invention may be combined with other components in order to form an agrochemical formulation comprising at least one agrochemical active.

The formulations of the present invention are water based suspension type formulations. In the concentrate form these are generally used to disperse water insoluble active ingredients where the dispersion is directly in the aqueous phase or absorbed in or adsorbed onto a solid support or as microencapsulated liquid or solutions of actives. These are commonly known as suspension concentrates (SC), in which the active compound is be present as a solid.

These aqueous agrochemical concentrates are agrochemical compositions designed to be diluted with water (or a water based liquid) to form the corresponding spray formulations.

Spray formulations are aqueous agrochemical formulations including all the components which it is desired to apply to the plants or their environment. Spray formulations can be made up by simple dilution of concentrates containing desired components (other than water).

The dispersants may therefore be incorporated into the formulation of the agrochemical active compound (in-can/built-in formulation).

According to the needs of the customer, concentrates thus formed may comprise typically up to 95 wt. % agrochemical actives based upon the total weight of the concentrate. Preferably, the concentrate may comprise 20 to 80 wt. % active. More preferably, 30 wt. % to 60 wt. % active. Most preferably, 40 wt. % to 50 wt. % active.

Said concentrates may be diluted for use resulting in a dilute composition having an agrochemical active concentration of about 0.5 wt. % to about 1 wt. %. In said dilute composition (for example, a spray formulation, where a spray application rate may be from 10 to 500 l.ha⁻¹) the agrochemical active concentration may be in the range from about 0.001 wt. % to about 1 wt. % of the total formulation as sprayed.

The copolymer dispersant of the present invention will typically be used in an amount proportional to the amount of the active agrochemical in the formulation. In agrochemical formulation concentrates, the proportion of the dispersant will depend on the solubility of the components in the liquid carrier. Typically, the concentration of the copolymer dispersant in such a concentrate will be from 1 wt. % to 20 wt. %. Preferably, from 1.5 wt. % to 10 wt. %. More preferably, from 2 wt. % to 5 wt. % based upon the total weight of the concentrate.

The concentration of phosphate ester present in a composition according to the present invention is preferably in the range from 0.5 to 20%, more preferably 0.6 to 10%, particularly 1.8 to 5%, and especially 1 to 3% based upon the total weight of the concentrate.

Where present in the concentrate formulation, the concentration of the graft copolymer in such a concentrate will be from 0.2 wt. % to 10 wt. %. Preferably, from 0.4 wt. % to 6 wt. %. More preferably, from 0.5 wt. % to 2 wt. % based upon the total weight of the concentrate.

The weight ratio of dispersant to phosphate ester in the concentrate is preferably from about 4:1 to about 1:1. More preferably, from about 3.5:1 to about 1.2:1 respectively. In particular, the weight ratio of dispersant to graft copolymer may be 3:1 to 1.5:1. Most preferably, from 2.5:1 to 1.8:1.

The weight ratio of dispersant to non-ionic graft copolymer, when present, in the concentrate is preferably from about 5:1 to about 1.5:1. More preferably, from about 4:1 to about 1.8:1 respectively. In particular, the weight ratio of dispersant to graft copolymer may be 3.5:1 to 2.5:1.

The weight ratio of the total of dispersant, phosphate ester, and when present graft copolymer, to active agrochemical in the concentrate and dilute concentrate agrochemical formulation is preferably from about 0.05:1 to about 0.2:1. More preferably, from about 0.7:1 to about 0.15:1. This ratio range will generally be maintained for concentrate forms of formulations (e.g. where the adjuvant is included in a dispersible liquid concentrate or dispersible solid granule formulation), and in the spray formulations.

When concentrates (solid or liquid) are used as the source of active agrochemical and/or dispersant and graft copolymer, the concentrates will typically be diluted to form the spray formulations. The dilution may be with from 1 to 10,000, particularly 10 to 1,000, times the total weight of the concentrate of water to form the spray formulation.

Where the agrochemical active is present in the aqueous end use formulation as solid particles, most usually it will be present as particles mainly of active agrochemical. However, if desired, the active agrochemical can be supported on a solid carrier e.g.

silica or diatomaceous earth, which can be solid support, filler or diluent material as mentioned above.

The spray formulations will typically have a pH within the range from moderately acidic (e.g. about 3) to moderately alkaline (e.g. about 10), and particular near neutral (e.g. about 5 to 8). More concentrated formulations will have similar degrees of acidity/alkalinity, but as they may be largely non-aqueous, pH is not necessarily an appropriate measure of this.

A particular problem is the crystal growth e.g. by “Ostwald ripening” of the active ingredient during relatively short time of storage. Crystal growth by “Ostwald ripening” generally occurs when smaller crystals (which have a larger surface area than bigger crystals”) dissolve in the aqueous phase and the material is transported through the continuous phase, to nucleation sites of bigger crystals. As a result, the crystals of the active ingredient may aggregate and sediment, the formulation becomes inhomogeneous; during application, filters and nozzles of the spray equipment can block and the biological efficacy may be reduced. In aqueous suspension concentrates, the aim of the dispersant is to prevent an excessive increase in crystal size.

Surprisingly, the dispersant combination of the present invention has been also found to have an effect in slowing and/or stopping crystal growth in active ingredients with propensity for crystal growth through “Ostwald ripening”.

In particular the dispersant combination is of use for crystal growth inhibition for actives of particular lipophilicity-i.e. hydrophobic poorly dispersible actives. In agrochemistry, the logarithm of the ratio of the concentrations of the unionised solute in two solvents, respectively octanol and water, is used as an index of the pesticide lipophilicity, and is known as the octanol/water coefficient, Ko/w or logP. The polymer of the invention consents the preparation of an aqueous agrochemical formulation containing from 50 to 1100 g/L of at least on pesticide having logP from −1.5 to +6.

Evaluation of parameters Ko/w or log P enable prediction of the risk of crystallization. This risk refers in concrete terms to what happens when 5 ml of the EC or EW is diluted with 95 ml of water and kept in a refrigerator (at 1° C.), after which the emulsion is passed through a 5 μm filter 7 days later. These experimental parameters primarily refer to the preferential tendency of solubilisation in water or octanol, known as the octanol/water partition coefficient, Ko/w or log P. The range of values of log P over which the invention is effective covers pesticides with a log P of between 2.5 and 4.5.

The formulation may also comprise additional component selected from pigments, dyes, micronutrients, agrochemical actives, bulking agents, and combinations thereof.

The agrochemical formulation may include solvents (other than water) such as monopropylene glycol, oils which can be vegetable or mineral oils such as spray oils (oils included in spray formulations as non-surfactant adjuvants), associated with the first and co-adjuvants. When used such solvents will typically be included in an amount of from 5 wt. % to 500 wt. %, desirably 10 wt. % to 100 wt. %, by weight of the dispersants. Such combinations can also include salts such as ammonium chloride and/or sodium benzoate, and/or urea especially as gel inhibition aids.

The agrochemical formulation may also include other components as desired. These other components may be selected from those including:
binders, particularly binders which are readily water soluble to give low viscosity solutions at high binder concentrations, such as polyvinylpyrrolidone; polyvinyl alcohol; carboxymethyl cellulose; gum arabic; sugars e.g. sucrose or sorbitol; starch; ethylene-vinyl acetate copolymers, sucrose and alginates,
diluents, absorbents or carriers such as carbon black; talc; diatomaceous earth; kaolin; aluminium, calcium or magnesium stearate; sodium tripolyphosphate; sodium tetraborate; sodium sulphate; sodium, aluminium and mixed sodium- aluminium silicates; and sodium benzoate,
disintegration agents, such as surfactants, materials that swell in water, for example carboxy methylcellulose, collodion, polyvinylpyrrolidone and microcrystalline cellulose swelling agents; salts such as sodium or potassium acetate, sodium carbonate, bicarbonate or sesquicarbonate, ammonium sulphate and dipotassium hydrogen phosphate;
wetting agents such as alcohol ethoxylate and alcohol ethoxylate/propoxylate wetting agents;
dispersants such as sulphonated naphthalene formaldehyde condensates and acrylic copolymers such as the comb copolymer having capped polyethylene glycol side chains on a polyacrylic backbone;
emulsifiers such as alcohol ethoxylates, ABA block co polymers, or castor oil ethoxylates;
antifoam agents, e.g. polysiloxane antifoam agents, typically in amounts of 0.005 wt. % to 10 wt. % of the formulation;
viscosity modifiers such as commercially available water soluble or miscible gums, e.g. xanthan gums, and/or cellulosics, e.g. carboxy-methyl, ethyl or propylcellulose; and/or
preservatives and/or anti-microbials such as organic acids, or their esters or salts such as ascorbic e.g. ascorbyl palmitate, sorbic e.g. potassium sorbate, benzoic e.g. benzoic acid and methyl and propyl 4-hydroxybenzoate, propionic e.g. sodium propionate, phenol e.g. sodium 2-phenylphenate; 1,2-benzisothiazolin-3-one; or formaldehyde as such or as paraformaldehyde; or inorganic materials such as sulphurous acid and its salts, typically in amounts of 0.01 wt. % to 1 wt. % of the formulation.

The agrochemical formulation according to the present invention may also contain components. Said surfactants may include surfactant dispersants.

Other adjuvants, such as surfactant adjuvants, may be included in the compositions and formulations of and used in this invention. Examples include alkylpolysaccharides (more properly called alkyl oligosaccharides); fatty amine ethoxylates e.g. coconut alkyl amine 2EO; and derivatives of alk (en) yl succinic anhydride, in particular those described in PCT applications WO 94/00508 and WO 96/16930.

The formulation may comprise at least one nutrient. Nutrients refer to chemical elements and compounds which are desired or necessary to promote or improve plant growth. Nutrients generally are described as macronutrients or micronutrients. Suitable nutrients for use in the concentrates according to the invention are micronutrient compounds, preferably those which are solid at room temperature or are partially soluble.

Micronutrients typically refer to trace metals or trace elements, and are often applied in lower doses. Suitable micronutrients include trace elements selected from zinc, boron, chlorine, copper, iron, molybdenum, and manganese. It is envisaged that the dispersant of the present invention would have broad applicability to all types of micronutrients.

The micronutrients may be in a soluble form or included as insoluble solids, and may in the form of salts or chelates. Preferably, the micronutrient is in the form of a carbonate or oxide.

Preferably, the micronutrient may be selected from zinc, calcium, molybdenum or manganese, or magnesium. Particularly preferred micronutrients for use with the present invention may be selected from zinc oxide, manganese carbonate, manganese oxide, or calcium carbonate.

The amount of micronutrient in the concentrate is typically from 5 wt. % to 40 wt. %, more usually, 10 wt. % to 35 wt. %, particularly 15 wt. % to 30, % by weight based on the total concentrate.

Typically, as mixed into formulations during make up the average particle size of solid agrochemicals is from 50 μm to 100 μm, but formulations are typically wet milled after mixing to reduce the average particle size to from 1 μm to 10 μm, more preferably from 1 μm to 5 μm.

The formulations of the present invention may also comprise at least one macronutrient. Macronutrients typically refer to those comprising nitrogen, phosphorus, and potassium, and include fertilisers such as ammonium sulphate, and water conditioning agents. Suitable macronutrients include fertilisers and other nitrogen, phosphorus, or sulphur containing compounds, and water conditioning agents.

Suitable fertilisers include inorganic fertilisers that provide nutrients such as nitrogen, phosphorus, potassium or sulphur. Examples of such fertilisers include:
for nitrogen as the nutrient: nitrates and or ammonium salts such as ammonium nitrate, including in combination with urea e.g. as uran type materials, calcium ammonium nitrate, ammonium sulphate nitrate, ammonium phosphates, particularly mono-ammonium phosphate, di-ammonium phosphate and ammonium polyphosphate, ammonium sulphate, and the less commonly used calcium nitrate, sodium nitrate, potassium nitrate and ammonium chloride;
for phosphorus as the nutrient: acidic forms of phosphorus such as phosphoric, pyrophosphoric or polyphosphoric acids, but more usually salt forms such as ammonium phosphates, particularly mono-ammonium phosphate, di-ammonium phosphate, and ammonium polyphosphate, potassium phosphates, particularly potassium dihydrogen phosphate and potassium polyphosphate;
for sulphur as the nutrient: ammonium sulphate and potassium sulphate, e.g. the mixed sulphate with magnesium.

Biostimulants may enhance metabolic or physiological processes such as respiration, photosynthesis, nucleic acid uptake, ion uptake, nutrient delivery, or a combination thereof. Non-limiting examples of biostimulants include seaweed extracts (e.g., ascophyllum nodosum), humic acids (e.g., potassium humate), fulvic acids, myoinositol, glycine, and combinations thereof.

The invention further includes a method of treating plants using formulations of the first aspect.

Accordingly, the invention further includes methods of use including:
a method of killing or inhibiting vegetation by applying to the vegetation, or the immediate environment of the vegetation e.g. the soil around the vegetation, a spray formulation including at least one dispersed phase agrochemical and the adjuvant of the first aspect; and/or
a method of killing or inhibiting pests of plants by applying to the plants or the immediate environment of the plants e.g. the soil around the plants, a spray formulations including at least one dispersed phase agrochemical which is one or more pesticides, for example insecticides, fungicides or acaricides, and the adjuvant of the first aspect.

As used herein, the term ‘dispersant’ or ‘dispersancy’ refers to compounds which when added to an agrochemical formulation will improve the agrochemical's desired effect. The dispersants may affect the diluent, the mixture, the active, or the target by its improvements of the active's performance.

Preferably, the dispersants of the present invention may find use as either the sole component or principal dispersancy functioning agents when formulated directly into pesticide concentrates.

The materials of the present invention dilute more readily in agricultural concentrates and develop lower fluid viscosities in aqueous systems, either in the concentrate or upon dilution into water prior to spraying. This behaviour provides improved ease of use in both manufacturing and upon dilution of products containing them, especially in colder waters. Reduction of foam stability is also observed which reduces the need for foam control agents. The dispersants of the present invention may be added to agrochemical formulations without undesirable thickening or destabilisation.

It will be appreciated that the dispersion comprises particles of low water solubility solids and therefore the particle size and distribution is a factor which reflects the stability of the dispersion. It is important that there is a homogeneous distribution of the particles to ensure stability of the dispersion for a longer period. Additionally, an effective dispersant ensures that the particles do not come together and cause phase separation. Therefore, a dispersion with small particle size, homogeneous particle distribution, and limited particle size growth over time, is likely to be a more stable dispersion.

In the form of a distribution of particle sizes, the particles would have a median volume particle diameter value. It will be understood that the median volume particle diameter refers to the equivalent spherical diameter corresponding to the point on the distribution which divides the population exactly into two equal halves. It is the point which corresponds to 50% of the volume of all the particles, read on the cumulative distribution curve relating volume percentage to the diameter of the particles i.e. 50% of the distribution is above this value and 50% is below. This value is referred to as the “D(v,0.5)” value and is determined as described herein.

Additionally, “D(v,0.9)” values can also be referred to, and these values would be the equivalent spherical diameter corresponding to 90% of the volume of all the particles, read on the cumulative distribution curve relating volume percentage to the diameter of the particles, i.e. they are the points where 10% of the distribution is above this value and 90% are below the value respectively.

The particle size values, used to determine the D(v,0.5), and D(v,0.9) values, are measured by techniques and methods as described in further detail herein. It will be understood that particle size values defined below are based on dispersant and graft copolymer at a total of 4.82 wt. % as shown in the Examples.

It is generally known that particle sizes of 1-10 μm are preferred in order to obtain a dispersion having the desired properties.

The particles present in the dispersants of the present invention may have an initial D(v,0.5) value at 0 days in the range from 0.1 μm to 8.0 μm. Preferably, in the range from 0.1 μm to 7.0 μm. More preferably, in the range from lum to 6.0 μm. Most preferably, in the range from lum to 6.0 μm.

The particles present in the dispersants of the present invention may have a D(v,0.9) value at 0 days in the range from 1.0 μm to 14.0 μm. Preferably, in the range from 2.0 μm to 10.0 μm. More preferably, in the range from 3.0 μm to 8.0 μm.

The particles present in the dispersants of the present invention may have a D(v,0.5) value at 7 days and 54° C. in the range from 1.0 μm to 20.0 μm. Preferably, in the range from 2.0 μm to 18.0 μm. More preferably, in the range from 3.0 μm to 15.0 μm. Most preferably, in the range from 3.5 μm to 13.0 μm.

The particles present in the dispersants of the present invention may have a D(v,0.9) value at 7 days and 54° C. in the range from 3.0 μm to 20.0 μm. Preferably, in the range from 4.0 μm to 15.0 μm. More preferably, in the range from 5.0 μm to 8.0 μm. Most preferably, in the range from 5.0 μm to 7.0 μm.

The particles present in the dispersants of the present invention, have a change in any or both of D(v,0.5) and D(v,0.9) between 0 days and 7 days when kept at 54° C. of no more than 300%, preferably no more than 200%, most preferably no more than 150%.

The dispersants of the present invention therefore provide good particle size and particle size distribution in a range desirable for an emulsion concentrate. In addition, the emulsions of the present invention maintain the desired particle sizes and particle size distribution under storage over time.

All of the features described herein may be combined with any of the above aspects, in any combination.

In order that the present invention may be more readily understood, reference will now be made, by way of example, to the following description.

It will be understood that all tests and physical properties listed have been determined at atmospheric pressure and room temperature (i.e. 25° C.), unless otherwise stated herein, or unless otherwise stated in the referenced test methods and procedures.

The following test methods were used to determine performance of the adjuvant compositions.

### EXAMPLES

The formulations were tested after storage for 24 hours at room temperature (RT) and after 7 and 14 days at 54° C. and assessed for:
Visual assessment for separation
pH (neat)
Viscosity (Neat, Brookfield viscometer, 10 rpm and 100 rpm)
Particle size distribution (PSD, Malvern Mastersizer, water cell SM2000)
Suspensibility (as per CIPAC MT 180)
Microscopy (10% dilution, Olympus BX51 Microscope, 20×polarised light)

Samples which had separated after heat storage were rolled for about 15 minutes before completing tests (60 rpm, benchtop rollers). In addition, the samples on Day 1 and Day 14 were also assessed for rheology performance (TA Discovery DHR-3 rheometer, DIN concentric cylinder, oscillation, creep, flow).

Samples were also assessed for crystal growth potential under conditions designed to promote crystal growth. All samples were diluted 0.1% in CIPAC D hard water (342 ppm Ca+ and Mg+). Samples were stored at 0° C. and 54° C. and assessed for particle size (Malvern Mastersizer 3000, water cell SM2000) after 1 and 7 days after storage.

The following materials were used in the examples:

### Dispersants

D1—Copolymer dispersant—co-polymer of MPEG-MA, AMPS, acrylic acid and styrene

D2—Non-ionic graft copolymer—Methyl methacrylate polymer with methacrylic acid and methoxy polyoxyethylene methacrylate

### Phosphate Ester Wetting Agents

W1—PEG-10 PPG-5 cetyl phosphate

W2—PEG-6 tridecyl mono/di phosphate

W3—PEG-12 Castor oil phosphate

W4—PEG-10 PPG-5 cetyl phosphate sodium salt

### Other Materials:

Flufenacet—Active (Glentham Life Science)

Prothioconazole—Active (Glentham Life Science)

Silcolapse 5020—Antifoam

Pricerine 9091—Antifreeze

Proxel GXL—Biocide

Kelzan RD—Rheology modifier

### Formulations Formed

A 10% total surfactant loading (15% for flufenacet) on active was used in a 3:1 ratio (dispersants:wetting agent). The dispersants, wetting agent and water were combined and mixed until fully solubilised (low shear mixing, 500 rpm). All other components were added and hand mixed with a spatula to mobilise.

The formulation was mixed with high shear for 2 minutes (Ultra Turrax, 13,500 rpm). The formulation was milled until the desired particle size was achieved d 0.9<10 μm (Eiger Mini Mill, 3,000 rpm). This was achieved milling the formulation for about 10 minutes.

Xanthan gum was produced in a separate vial using 10% of the water phase and Pricerine, and was homogenised into the mixture post milling.

The following formulations were made, where F1 to F5 and P1 to P5 were formulations of the present invention.

TABLE 1
Formulations formed (values are .wt %)-Flufenacet

| Component | F1 | F2 | F3 | F4 | F5 |
|---|---|---|---|---|---|
| Flufenacet | 43.36 | 43.36 | 43.36 | 43.36 | 43.36 |
| D2 | 1.61 | | 1.61 | 1.61 | 1.61 |
| D1 | 3.21 | 4.82 | 3.21 | 3.21 | 3.21 |
| W1 | 1.61 | 1.61 | | | |
| W2 | | | 1.61 | | |
| W3 | | | | 1.61 | |
| W4 | | | | | 1.61 |
| Silcolapse 5020 | 0.09 | 0.09 | 0.09 | 0.09 | 0.09 |
| Pricerine 9091 | 4.28 | 4.28 | 4.28 | 4.28 | 4.28 |
| Proxel GXL | 0.17 | 0.17 | 0.17 | 0.17 | 0.17 |
| Kelzan RD | 0.21 | 0.21 | 0.21 | 0.21 | 0.21 |

Remainder of formulations F1-F5 and P1-P5 up to 100 wt. % using deionized water.

TABLE 2
Formulations formed (values are .wt %)-Prothioconazole

| Component | P1 | P2 | P3 | P4 | P5 |
|---|---|---|---|---|---|
| Prothioconazole | 45.25 | 45.25 | 45.25 | 45.25 | 45.25 |
| D2 | 0.84 | | 0.84 | 0.84 | 0.84 |
| D1 | 2.53 | 4.50 | 2.53 | 2.53 | 2.53 |
| W1 | 1.13 | 1.13 | | | |
| W2 | | | 1.13 | | |
| W3 | | | | 1.13 | |
| W4 | | | | | 1.13 |
| Silcolapse 5020 | 0.50 | 0.50 | 0.50 | 0.50 | 0.50 |
| Pricerine 9091 | 6.00 | 6.00 | 6.00 | 6.00 | 6.00 |
| Proxel GXL | 0.10 | 0.10 | 0.10 | 0.10 | 0.10 |
| Kelzan RD | 0.15 | 0.15 | 0.15 | 0.15 | 0.15 |

### Results

The following results were obtained for the concentrate formulations of Tables 1 & 2.

TABLE 3
Results for concentrates with flufenacet

| | F1 | | F2 | | F4 | | F5 | |
|---|---|---|---|---|---|---|---|---|
| | D 1 | D 14 | D 1 | D 14 | D 1 | D 14 | D 1 | D 14 |
| Test | RT | 54° C. | RT | 54° C. | RT | 54° C. | RT | 54° C. |
| Visual | NS | Trace | NS | 7% st | NS | NS | NS | NS |
| Viscosity (cP) | 1,950 | 1,475 | 1,700 | 1,150 | 2,200 | 1,800 | 2,975 | 1,775 |
| at 10 rpm | | | | | | | | |
| Viscosity (cP) | 172.5 | 138 | 290 | 247.5 | 325.5 | 254 | 510 | 345 |
| at 100 rpm | | | | | | | | |
| Suspensibility % | 103 | 101 | 98 | 91 | 99 | 95 | 101 | 101 |
| PSD (μm) of | 1.94 | 5.34 | 0.106 | 8.48 | 0.117 | 6.62 | 1.34 | 5.42 |
| D(0.5) | | | | | | | | |
| PSD (μm) of | 6.56 | 9.8 | 3.99 | 17.6 | 2.61 | 12 | 4.36 | 9.6 |
| D(0.9) | | | | | | | | |

st—separation and NS means no separation
PSD—particle size dispersion
D 1, D 14—is day 1 and day 14 respectively
RT—room temperature

Table 3 shows the particle size/crystal growth remain under control with just the core components of the invention and the further synergistic improvement in terms of dispersion performance and slow crystal growth (smaller increase in PSD) when incorporating the optional component. The formulations both at room temperature over 14 days, and at higher temperature over 14 days. The formulations showed little if any decrease in suspensibilty and better particle size control, with little viscosity change whilst using a variety of phosphate ester components.

TABLE 4
Results for concentrates with prothioconazole

| | P1 | | P2 | | P3 | | P4 | |
|---|---|---|---|---|---|---|---|---|
| | D 1 | D 14 | D 1 | D 14 | D 1 | D 14 | D 1 | D 14 |
| Test | RT | 54° C. | RT | 54° C. | RT | 54° C. | RT | 54° C. |
| Visual | NS | 5% st | NS | NS | NS | 20% st | NS | 8% St |
| Viscosity (cP) | 750 | 525 | 3900 | 1100 | 950 | 424 | 950 | 790 |
| at 10 rpm | | | | | | | | |
| Viscosity (cP) | 137.5 | 115 | 692.5 | 187.5 | 257.5 | 107.5 | 158 | 124 |
| at 100 rpm | | | | | | | | |
| Suspensibility % | 101 | 97 | 93 | 91 | 96 | 99 | 98 | 97 |
| PSD (μm) of | 1.38 | 1.7 | 1.64 | 2.34 | 2 | 1.74 | 2.12 | 2.41 |
| D(0.5) | | | | | | | | |
| PSD (μm) of | 3.41 | 3.79 | 5.91 | 9.82 | 6 | 5.82 | 3.98 | 4.52 |
| D(0.9) | | | | | | | | |

st—separation and NS means no separation
PSD—particle size dispersion
D 1, D 14—is day 1 and day 14 respectively
RT—room temperature

Table 4 shows synergistic improvement in terms of dispersion performance and slow crystal growth (smaller increase in PSD) in the formulations both at room temperature over 14 days, and at higher temperature over 14 days. Formulation P2 comprising of the fundamental parts of the invention shows commercially acceptable control over the formulations crystal growth. The other formulations showed little if any decrease in suspensibility and better particle size, with little viscosity change when the optional component is included.

### Crystal Growth Results

The concentrates of Tables 1 and 2 were then diluted down and particle size dispersion was measured again at low and high temperature over seven days. The particle size dispersion results are shown in Tables 5 and 6 (with D(v,0.5) and D(v,0.9) values in μm).

TABLE 5
Results for concentrates with flufenacet

| Dilute | | | Day 0^{†} | | Day 1 | | Day 7 | |
|---|---|---|---|---|---|---|---|---|
| formulation of | Temperature | | D0.5 | D0.9 | D0.5 | D0.9 | D0.5 | D0.9 |
| F1 | 0° | C. | 1.94 | 6.56 | 3.48 | 6.68 | 3.1 | 6.16 |
| F1 | 54° | C. | | | 3.51 | 6.22 | 2.76 | 6.69 |
| F2 | 0° | C. | 0.106 | 3.99 | 1.54 | 6.23 | 3.42 | 6.94 |
| F2 | 54° | C. | | | 4.63 | 9.4 | 5.04 | 14.7 |
| F4 | 0° | C. | 0.117 | 2.61 | 0.114 | 2.4 | 0.166 | 4.18 |
| F4 | 54° | C. | | | 0.14 | 3.36 | 1.72 | 5.69 |
| F5 | 0° | C. | 1.34 | 4.36 | 1.11 | 3.19 | 1.56 | 5.11 |
| F5 | 54° | C. | | | 2.9 | 5.13 | 3.85 | 6.82 |

^{†}Day 0 measurements performed at room temperature

Table 5 shows the crystal growth results for all the formulations tested with the agrochemical active flufenacet. The results clearly show the formulation of the present invention having acceptable particle size dispersion over seven days and therefore good crystal growth suppression. This shows that even when the concentrate is diluted to 5% the crystal growth suppression effect can still be seen. When the optional component is incorporated a further improvement can be seen.

TABLE 6
Results for concentrates with prothioconazole

| Dilute | | | Day 0^{†} | | Day 1 | | Day 7 | |
|---|---|---|---|---|---|---|---|---|
| formulation of | Temperature | | D0.5 | D0.9 | D0.5 | D0.9 | D0.5 | D0.9 |
| P1 | 0° | C. | 1.38 | 3.41 | 1.94 | 5.36 | 2.69 | 6.1 |
| P1 | 54° | C. | | | 2.54 | 5.91 | 3.11 | 7.89 |
| P2 | 0° | C. | 1.64 | 5.91 | 1.09 | 3.4 | 1.83 | 8.22 |
| P2 | 54° | C. | | | 1.11 | 3.29 | 1.18 | 3.83 |
| P3 | 0° | C. | 2 | 6 | 1.74 | 6.31 | 1.47 | 6.98 |
| P3 | 54° | C. | | | 0.845 | 4.08 | 0.889 | 4.13 |
| P4 | 0° | C. | 1.83 | 6.06 | 2.24 | 7.59 | 2.53 | 7.43 |
| P4 | 54° | C. | | | 6.63 | 9.3 | 6.29 | 10.5 |

^{†}Day 0 measurements performed at room temperature

Table 6 shows the crystal growth results for all the formulations tested with the agrochemical active prothioconazole. The results clearly show the formulation of the present invention having good particle size dispersion over seven days and therefore good crystal growth suppression. This shows that even when the concentrate is diluted to 5% the crystal growth suppression effect can still be seen. When the optional component is incorporated a further improvement can be seen.

It is to be understood that the invention is not to be limited to the details of the above embodiments, which are described by way of example only. Many variations are possible.

1. A suspension type water medium agrochemical formulation comprising:
i) a copolymer dispersant comprising a copolymer of acrylic acid, a hydrophobic monomer, an alkylacrylate of a monoalkyl polyethylene glycol, and optionally strong acid derivatives of (meth)acrylic acid;
ii) a C10 to C30 alkoxylated mono- and/or di-ester phosphate;
iii) optionally a non-ionic graft copolymer of an acrylic ester and an oxyalkylene; and
iv) at least one hydrophobic solid agrochemical active dispersed in the water medium.

2. The formulation according to claim 1, wherein the acrylic acid monomer is selected from (meth)acrylic acid or salts thereof, (meth)acrylamide, (meth)acrylonitrile, C1-6-alkyl (meth)acrylates, butyl (meth)acrylate or hexyl (meth)acrylate, 2-ethylhexyl (meth)acrylate, substituted C1-6-alkyl (meth)acrylates, di(C1-4-alkylamino)C1-6-alkyl (meth)acrylates, amides formed from C1-6-alkylamines, substituted C1-6-alkyl-amines.

3. The formulation according to claim 1, wherein the acrylic acid monomer is acrylic acid, methacrylic acid, crotonic acid, or a mixture thereof.

4. The formulation according to claim 1, wherein the hydrophobic monomer is selected from hydrophobic alkyl (meth)acrylates, styrenes, and vinyl compounds, and vinyl aromatic monomers.

5. The formulation according to claim 4, wherein the hydrophobic monomer is a vinyl aromatic monomer selected from styrene or an alkyl substituted styrene.

6. The formulation according to claim 1, wherein the alkylacrylate of a monoalkyl polyethylene glycol is a methoxy polyethylene glycol methacrylate (MPEGMA).

7. The formulation according to claim 1, where the strong acid derivatives of (meth)acrylic acid is selected from acrylamido methyl propyl sulphonate (AMPS) or (meth)acrylic acid isethionate.

8. The formulation according to claim 1, wherein the C10 to C30 alkoxylated mono- and/or di-ester phosphate is
a monoester phosphate that is a compound of formula R¹-(AO)ₙ—O—P(═O)(OH)₂; and/or
a diester phosphate of formula —R²-(AO)ₙ—O—P(═O)—O-(AO)ₙ—R³)(OH).
wherein R¹, R², and R³ are independently a saturated linear C10 to C30 alkyl group, and AO represents an oxyalkylene group selected from oxyethylene, oxypropylene, or oxybutylene.

9. The formulation according to claim 1, wherein the phosphate ester is selected from cetyl (10 EO, 5 PO) mono ester phosphate, cetyl (10 EO, 5 PO) di ester phosphate, stearyl (10 EO, 5 PO) mono ester phosphate, stearyl (10 EO, 5 PO) di ester phosphate, tridecyl (6 EO) mono ester phosphate, tridecyl (6 EO) di ester phosphate, castor oil (12 EO) mono phosphate, and castor oil (12 EO) di phosphate.

10. The formulation according to claim 1, wherein the molecular weight of the non-ionic graft copolymer of acrylic ester and oxyalkylene is from 5,000 to 40,000.

11. The formulation according to claim 1, wherein the non-ionic graft copolymer of acrylic ester and oxyalkylene is non-ionic polymethyl methacrylate-polyethylene oxide graft copolymer.

12. The formulation according to claim 1, wherein the hydrophobic solid agrochemical active is selected from the herbicides flufenacet, or metribuzin; azoles fungicides difenoconazole, cyproconazole, prothioconazole; or insecticides buprofezin or azoxystrobin.

13. A concentrate formulation suitable for making an agrochemical formulation of the first aspect, the concentrate comprising:
i) a copolymer dispersant comprising a copolymer of acrylic acid, a hydrophobic monomer, an alkylacrylate of a monoalkyl polyethylene glycol, and optionally strong acid derivatives of (meth)acrylic acid;
ii) a C10 to C30 alkoxylated mono- and/or di-ester phosphate;
iii) optionally a non-ionic graft copolymer of acrylic ester and an oxyalkylene; and
iv) at least one hydrophobic solid agrochemical active dispersed in said the water medium.

14. Use of a combination of:
a copolymer of acrylic acid, a hydrophobic monomer, an alkylacrylate of a monoalkyl polyethylene glycol, and optionally strong acid derivatives of (meth)acrylic acid;
a C10 to C30 alkoxylated mono- and/or di-ester phosphate; and
optionally a non-ionic graft copolymer of acrylic esters and an oxyalkylene;
as a dispersant in an agrochemical formulation comprising a hydrophobic solid agrochemical active.

15. A method of treating vegetation to control pests, the method comprising applying a formulation of the first aspect, and/or a diluted concentrate formulation of the second aspect, either to the vegetation or to an immediate environment of the vegetation.
